(19) United States
(12) Patent Application Publication
(10) Pub. No.: US 2009/0299828 A1
(43) Pub. Date: Dec. 3, 2009

(54) Scoreboard for Managing Bank Teller Performance Variability

(75) Inventors: Thomas Riddick, Charlotte, NC (US); Rob W. Johnston, JR., Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/323,826

(22) Filed: Nov. 26, 2008

Related U.S. Application Data
(60) Provisional application No. 61/057,657, filed on May 30, 2008.

(51) Int. Cl. G06Q 10/00; G06Q 40/00

(52) U.S. Cl. 705/11

(57) ABSTRACT

Methods and systems for a performance measurement are disclosed to reduce teller performance variation. The process may generate individual and organizational report views of both actual performance and process capability of banking tellers. The performance may be based on one or more actual teller or teller-related performance metrics. The performance may then be compared to, for example, “Best-in-Class” performance, ranked amongst others, and/or analyzed for trends and process capability. Finally, underperforming tellers may be coached for improvement in those areas where rankings were low.

### RELATED APPLICATIONS

This application claims priority from U.S. Provisional Patent Application Ser. No. 61/057,657, filed May 30, 2008, entitled, “SCOREBOARD FOR MANAGING BANK TELLER PERFORMANCE VARIABILITY.” The aforementioned provisional application is hereby incorporated by reference in its entirety.

### BACKGROUND

Performance and performance variability of employees may be monitored in a variety of ways. One such tool used in the past, by the assignee of the instant application, monitored performance variability of call center associates. The tool provided individual and organizational reports of actual performance of call center associates and process capability. The performance was based on a number of call center performance metrics, whereby the call center associate was provided an overall percentage that rank his/her performance relative to other call center associates.

No such application, however, exists for monitoring performance variability for bank tellers. Moreover, no such application provided any indication of the bank teller's performance according to specific performance metrics or how the bank teller's performance compared to the performance expectations of the institution. Further, because there was no performance metric-specific information, any coaching to improve performance in any area was not individualized. Bank tellers generally are amongst the largest population of any position at a bank potentially constituting tens of thousands of employees across the country. Moreover, bank tellers play an important role in the daily operations of bank branches. For example, bank tellers are the primary points of contact with bank customers, process millions of cash transactions, and are the source of a substantial percentage of referrals of other services offered by the bank. Accordingly, bank teller performance can substantially impact the financial operations of any branch bank.

Bank teller performance may vary considerably and it may therefore be desirable to monitor performance variations and provide a mechanism to provide coaching to underperforming bank tellers based on the areas requiring improvement.

### BRIEF SUMMARY

This summary is provided to introduce a selection of concepts in a simplified form that are further described in the Detailed Description. The summary is not intended to identify key features or essential features of the claimed subject matter, nor is it intended to limit the scope of the claimed subject matter.

In one aspect, a performance measurement tool is disclosed to reduce bank teller performance variation. The tool may include individual and organizational report views of both actual performance and process capability. The performance may be based on one or more actual teller or teller-related performance metrics. The performance may then be graded for a level of performance and/or analyzed for trends and process capability. For example, a “Best-in-Class” performance may be provided that ranks the bank teller amongst others. Moreover, each teller may be provided a performance level rating for each performance metric being measured that indicates performance expectations of bank tellers across the institution and provides a mechanism for the institution to vary desired performance levels.

In an embodiment, a process is disclosed that receives source data feeds as they become available (e.g., daily, weekly, monthly, quarterly, etc.) and run this through batch processes to generate reports and tools. The reports (i.e., scoreboards) provide a single place for bank teller or their managers to view their own performance as ranked and measured against Best-In-Class (BIC) performance. BIC may represent, for example, the process capability of tellers.

Bank teller performance may be measured against the local branch, the region, the division, or the bank's enterprise. The process also provides coaching tools for the bank teller associate to take action in a timely fashion to effectively impact the behaviors driving variation.

### BRIEF DESCRIPTION OF THE DRAWINGS

FIG. 1 illustrates a high-level computing environment in which one or more aspects described herein may be implemented.

FIG. 2 illustrates a network environment in which one or more aspects described herein may be implemented.

FIG. 3 is a flow chart illustrating an embodiment of a process for generating performance information for bank tellers from across an enterprise.

FIG. 4 illustrates an example of a performance scorecard for a plurality of bank tellers.

FIG. 5 illustrates a detailed report for a particular teller.

FIG. 6 illustrates a market level chart reflecting the overall performance by tellers at the various bank branches within a given market.

FIG. 7 provides a regional level report of the performance of the various markets.

FIG. 8 provides divisional level report of the performance of the various divisions.

FIG. 9 and FIG. 10 illustrate how tellers may be coached to improve their performance toward process capability.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

### Overall Computing Network

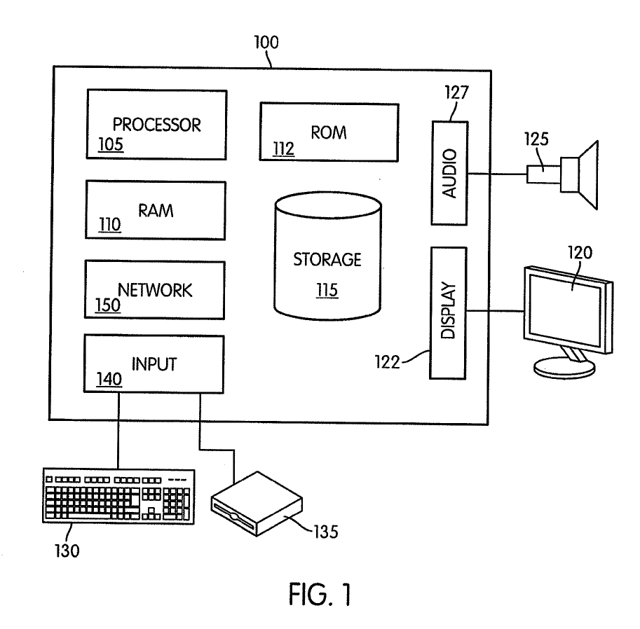

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

A computing device such as computer 100 may house a variety of components for inputting, outputting, storing and processing data. Computer 100 may include desktop computers, laptop computers, ultra mobile PCs, servers and the like. Processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the processor 105 is executing the application.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one or more instances, a device such as media drive 135 may act as both an input and output device allowing users to both write and read data to and from the storage media (e.g., DVD-R, CD-RW, etc.).

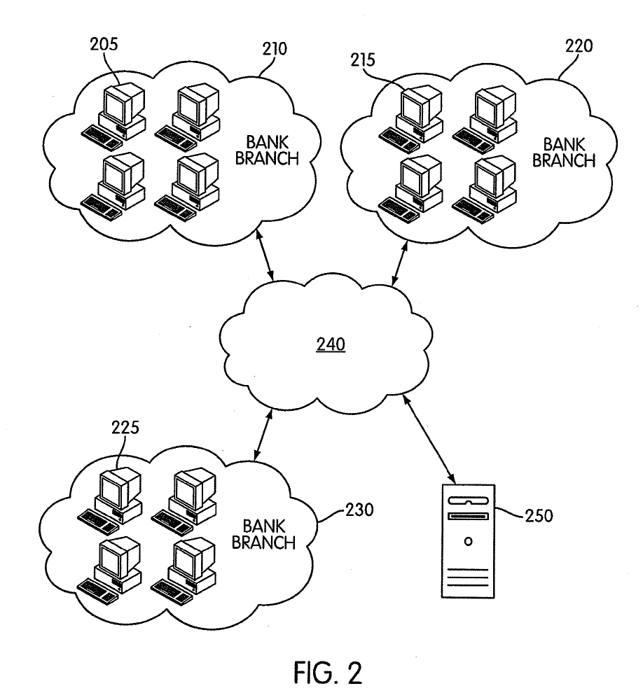

Computer 100 may further include one or more communication components for receiving and transmitting data over a network. Various types of networks include cellular networks, digital broadcast networks, Internet Protocol (IP) networks, local area networks (LAN), wide area networks (WAN), and the like. Computer 100 may include adapters suited to communicate through one or more of these networks. In particular, computer 100 may include network adapter 150 for communication with one or more other computer or computing devices over an IP network (e.g., see FIG. 2). In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

One of skill in the art will appreciate that computing devices such as computer 100 may include a variety of other components and is not limited to the devices and systems described in FIG. 1.

FIG. 2 illustrates a simplified enterprise network environment of a financial institution such as a bank. Each of the computing devices 205, 215, 225 may take the form of computer 100 (discussed above) and may communicate with each other and other computers or systems (e.g., server 250). Computing device 205, 215, and 225 may receive and send information to any other device connected to the network 240 (e.g. server 250) via a closed network, the Internet, and the like according to one or more illustrative aspects. The processes described herein may be performed within any part of this distributed computing network.

### Overall Process for Generating Bank Teller Variability Information

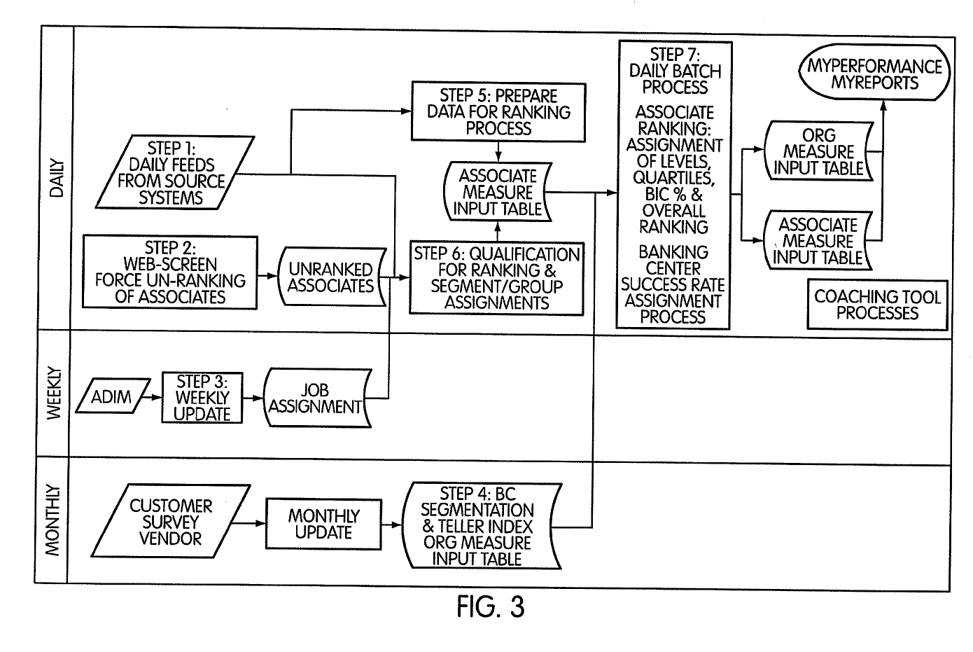

FIG. 3 is a flow chart illustrating an embodiment of a process for generating performance information for bank tellers from across an enterprise. In an embodiment, this process may run after all required data files are received and may run daily, weekly, monthly, or any other desired frequency.

At step 1, various forms of data are obtained from daily feeds from various source systems. This information includes generally data from various source systems from the each local branch and may include, for example, Teller Exception Balancing System (TEBS); Teller Referral Tracking System (TRTS); Teller Transaction Processing Time System (TTPTS); administrative systems (e.g., FIDELITY), LEEGEM, customer survey vendors (e.g., MARITZ), etc. At step 4, periodic updates may also be provided from customer survey vendors (e.g., MARITZ). This information may be obtained, for example, daily (e.g., overnight relating to the prior business day's performance), weekly, monthly, etc. Data from each of these source systems may be provided to a Performance Management Reporting (PMRR) system. At step 5, the performance data from the various sources is prepared for the ranking process.

At step 2, the process may allow administrators to not rank particular tellers, which information would also be provided. This step may be utilized by managers to unrank associates, for example, for performance reasons for a period of time (start and end date). At step 3, the process may allow administrators to add and remove tellers from the system, which information would also be provided. This process may use, for example, Job Code, Hire Date, 703 Enrollment Status for its tellers.

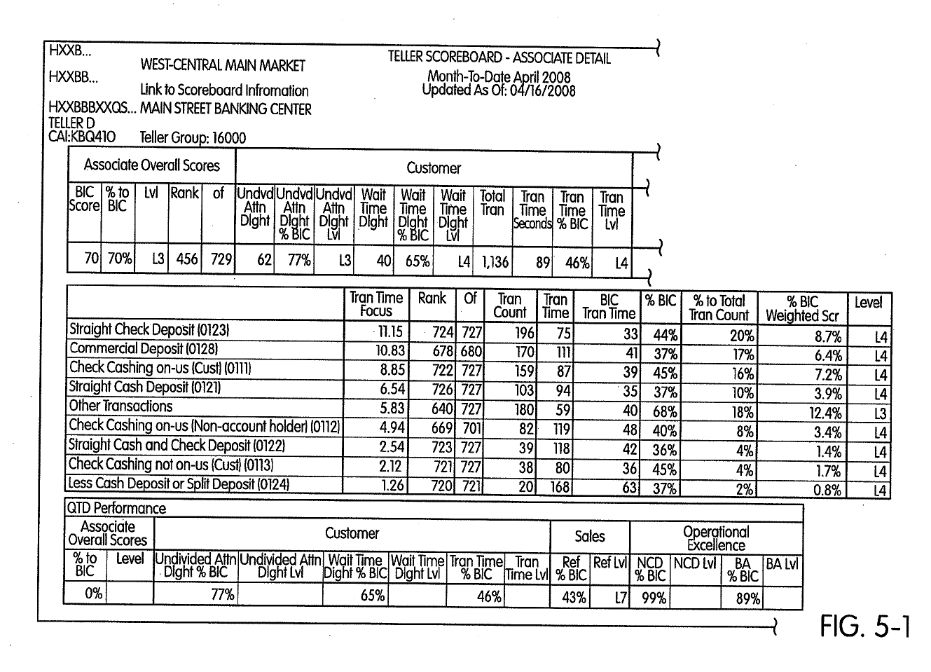

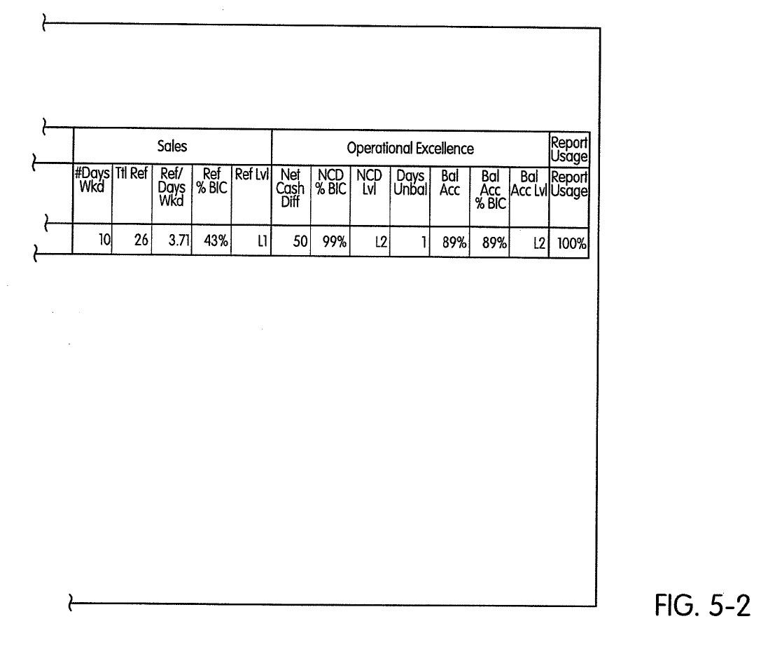

At step 6, the process receives the daily feed information (step 1), information relating to tellers that should not be ranked (step 2), and any new or former tellers (step 3) and selects the banking center enrolled tellers and determines if they qualify for ranking and assigns all segment code codes. At this point, certain tellers may not be ranked because they have not satisfied certain threshold requirements. Such unranked tellers are illustrated, by way of example, as Tellers E, F, and G in the scorecard of FIG. 5. For example, the process could determine not to rank those tellers that are new (e.g., within ninety days) or those that haven't hit a minimum threshold of days worked or transactions processed.

The information from steps 5 and 6 is then processed to prepare tables, which are then provided for batch processing. At step 7, the process performs a batch process of all of the received data from the various tellers across the enterprise to generate teller scorecards (discussed below). This process creates and saves final Ranking Measure codes as well as creates metrics for minimum level/quartile values, etc. In an embodiment, the batch processing may be performed overnight. Various reports such as Organization Measure Input Table (i.e., organization-based reports) and/or Associate Measure Input Table (associate-based reports) may be generated. Other reports, such as daily MyPerformance or MyReports, may thereby be generated from the batch processing. Any number of reports may be generated including but not limited to Banking Center Tellers, Franchise Tellers by Segment/Group, Banking Center Teller Detail, Banking Center Success Rate reports at each Hierarchy Level (Market, Region, Division), Coaching Reports, etc. Based on these reports and as discussed herein, a coaching wizard may be utilized to improve underperforming tellers in areas requiring improvement.

### Bank Teller Scorecard

In general, the performance scorecard generated by the above process provides information relating to (1) the ranking of each teller amongst others; (2) how each teller is performing in a plurality of performance metrics in relation to minimum standards, other tellers, and/or the top performing tellers; (3) what tellers are in the top and what tellers in the bottom as to each performance metric as well as overall; and/or (4) the level variance in performance amongst the tellers. With this information, the institution may establish requisite levels of performance and take appropriate action to improve performance by underperforming tellers.

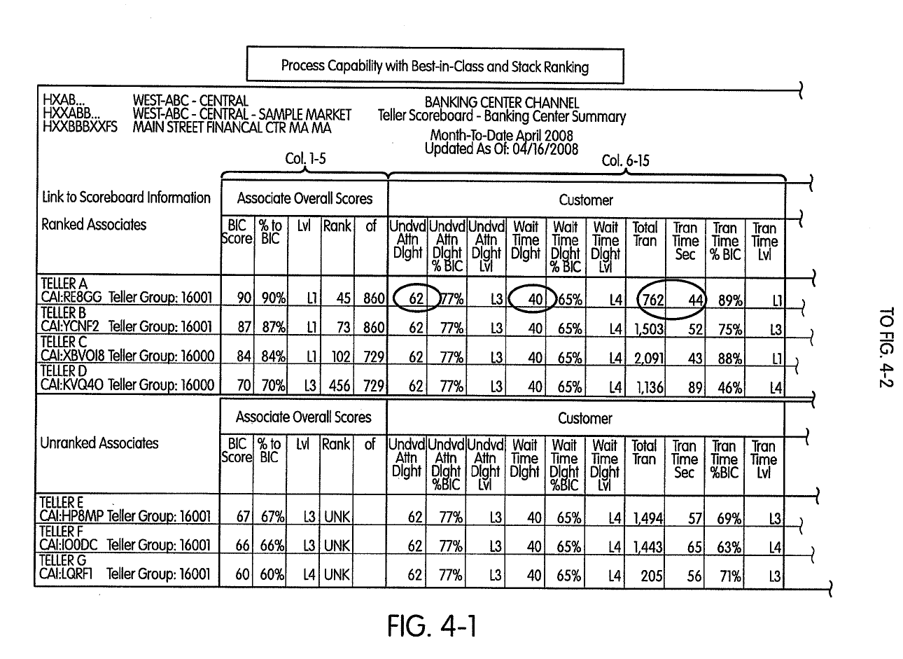

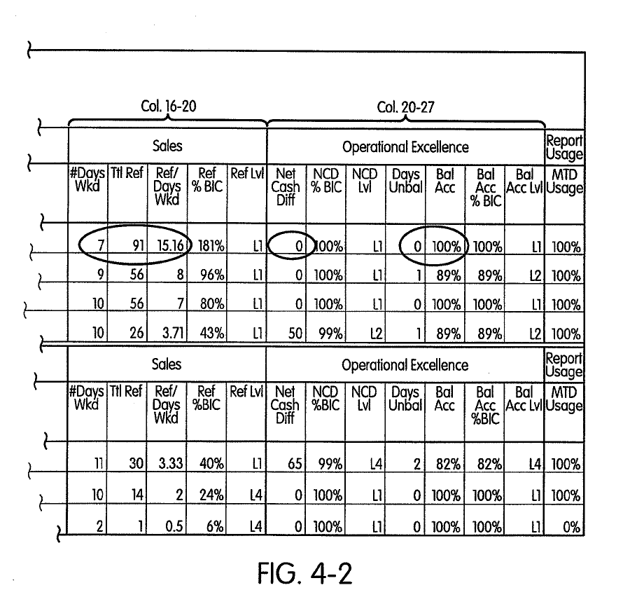

FIGS. 4-10 illustrate various features of the bank teller scorecard. Starting with FIG. 4, depicted is an example of a performance scorecard for a plurality of bank tellers. As depicted, the scorecard reflects performance information for a particular banking center. Performance information for seven bank tellers is shown with three of these bank tellers not having been ranked. The remaining four bank tellers have been ranked. Optionally, for certain tellers (such as those that were recently hired or that have not had enough transactions logged), the system may provide performance information but not ranked tellers amongst other tellers.

For each bank teller, the scorecard provides an overall view of his/her performance across all metrics being monitored (columns 1-5). It will be appreciated that any number of performance metrics may be monitored. In this example, three categories of performance are monitored (customer performance (columns 6-15), sales performance (columns 16-20), and operational excellence (columns 20-27)) and involve six different types of performance metrics, as well as how often the scoreboard is viewed by the associate.

In terms of customer performance, each teller's performance as to “undivided attention delight,” “wait time delight,” “total transactions,” and/or “transaction time” may be monitored. Performance metrics such as “undivided attention delight” and “wait time delight” may be obtained from customer satisfaction surveys taken of customers. The “total transactions” and “transaction time” may be obtained simply from the computing system utilized by the bank teller.

In terms of sales, the “number of days worked,” “total referrals made” (i.e., referrals to banking customers of other products/services offered by the institution), and/or “referrals/days worked” may be monitored. These performance metrics may be monitored either through the bank's computing system or may be manually entered at the bank branch.

Finally, in terms of operational excellence, “net cash difference” and/or “days unbalanced” may be monitored. Again, these performance metrics may be monitored either through the bank's computing system or may be manually entered at the bank branch. “Net cash difference” provides running total information as to the amount of money that the teller is off by in his/her cash drawer (may be other than zero as long the difference is less than a specified amount such as $25). For example, Teller E has worked 11 days and he has lost $65 in his cash drawer. As another example, Teller B was out of balance one day (column 23) of the 9 days she worked (column 16), but since her net cash different was less than $25, her net cash difference value (column 20) remains at zero.

In accordance with an embodiment of the present invention, a performance level indicator operation is provided that determines the performance expectations of bank tellers across the institution and provides a mechanism for the institution to vary desired performance levels. In particular, a “Best-in-Class” or “BIC” determination is provided. BIC refers to the top percent of associates for any given performance metric. In the example, BIC refers to the top 25% of bank tellers (although any percentile number could be used) and is given a performance level of “L1.” In the example for sales performance, BIC (i.e., top 25%) tellers are averaging a little over 8 referrals per day (8.33 referrals). This BIC performance may thereby represent the process capability of all tellers across the bank. Process capability may represent a measure of productivity and performance that is more reflective of realistic performance goals, as opposed to an arbitrarily-set goal. Lower performance levels may be set by the business according to business expectations and any number of techniques may be used to set—and subsequently adjust—these performance levels to suit the business needs of the institution. In the example, L1 may mean that the bank teller is performing at a BIC level and therefore exceeding business expectations, L2 may mean that bank teller is meeting business expectations, L3 may mean that the bank teller is just bellow meeting business expectations, and L4 may mean that the bank teller is below and therefore not meeting business expectations. Accordingly, a performance level can be assigned to each performance metric as well as the overall performance that indicates whether or not the teller is performing according to the institution's expectations.

For example, Teller A has worked 7 days so far the month, has made 91 one referrals, and is averaging 15.16 referrals per day. The next column “Ref % BIC” refers to referrals as a percent of the average performance amongst those in BIC. This column shows that Andy is performing well above the BIC average of approximately 8 (100×(15.16/8.33)). As another example, Teller G whose referrals per day is only 0.5 and whose referrals as a percent of BIC is only 6%. In other words, out of all full-time tellers across the franchise (the top 25% of which are averaging at little over 8 referrals/day), Teller G is 6% of that BIC (or that he is achieving only 6% of what of what the company's best 25% tellers are averaging).

Again, the disclosure contemplates that any number of performance metrics may be monitored for performance analysis in accordance with the present disclosure. Moreover, the scorecard may be periodically updated and available for viewing. For example, the scorecard may be updated daily such that relevant data is pulled overnight so that the scorecard is updated and available for viewing sometime the next business day.

Also depicted is an overall score/ranking, which combines, and optionally weights, each of the performance metrics. Moreover, the bank tellers may be segmented into multiple segments and accordingly ranked within their respective segments. For example, bank tellers may be segmented according to geographic region. Moreover, tellers could be segmented according to seniority and/or part-time or full-time status. Columns 4 and 5 provide an overall ranking of the bank teller according to his/her segment. For example, Teller A is ranked 45 out of 860 tellers in his segment in the overall composite ranking. In contrast, Teller D is ranked 456 of 729 tellers in his segment.

Final column 28 refers to Report Usage which shows how many days out of the month that the teller worked that he/she accessed the scorecard report. For example, Teller A worked seven days in April (column 16) and of those seven days, he looked at the scorecard report every single day (i.e., 100% in column 28).

FIG. 5 illustrates a detailed report for a particular teller. In an embodiment, the scorecard of FIG. 4 may have hyperlinked names that link to the detailed report of FIG. 5. FIG. 5 may also provide focus to relevant areas for the teller based on the stack ranking of the detail performance from worst to best.

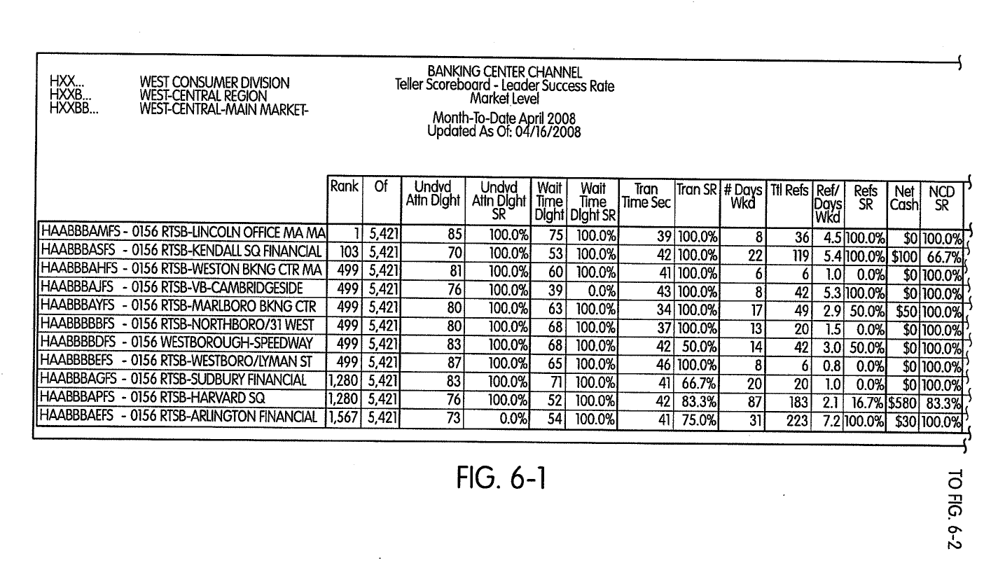

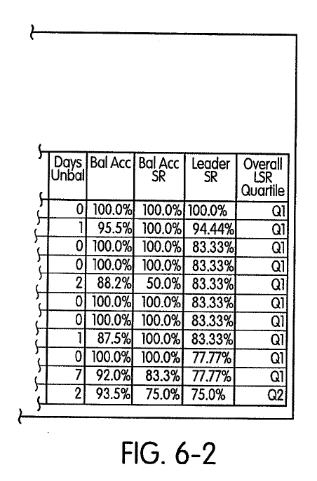

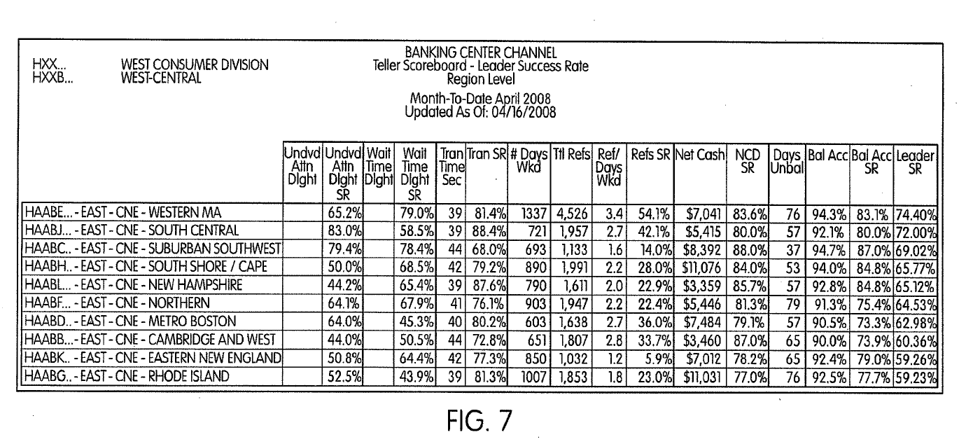

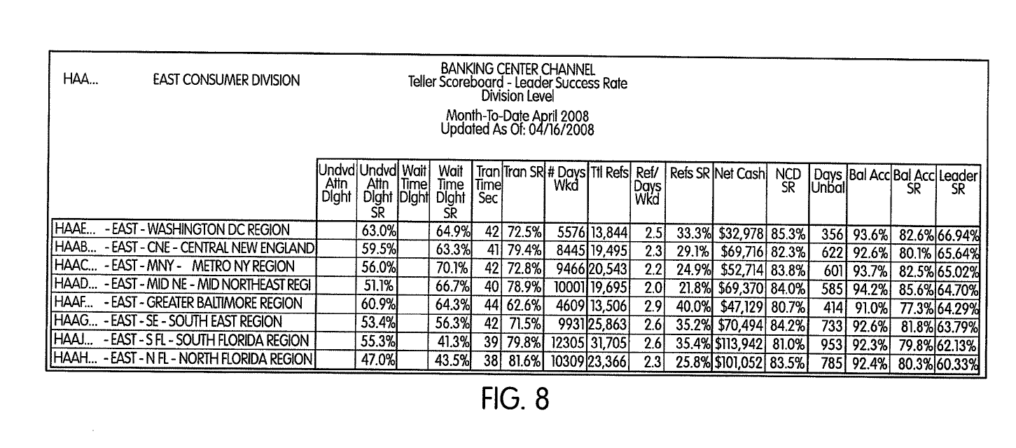

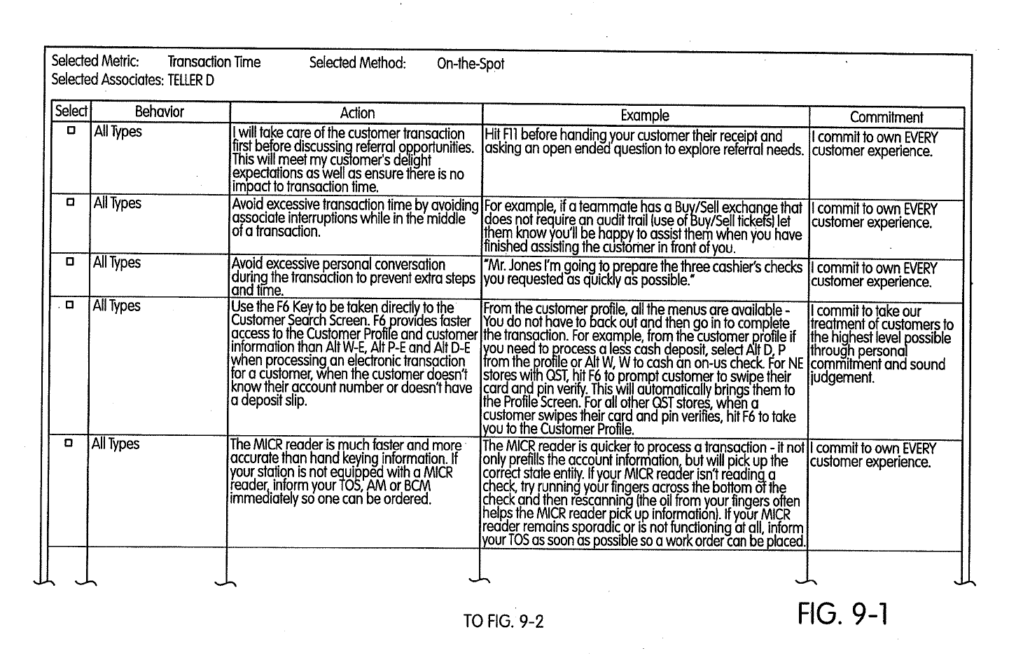

FIG. 6 illustrates a market level chart reflecting the overall performance by tellers at the various bank branches within a given market. The chart provides an overall ranking of the bank branch, and overall scores relating to the various performance metrics being monitored. Similarly, FIG. 7 provides a regional level report of the performance of the various markets. Likewise, FIG. 8 provides divisional level report of the performance of the various divisions. Such reports may be generated and viewed by various individuals within the organization.

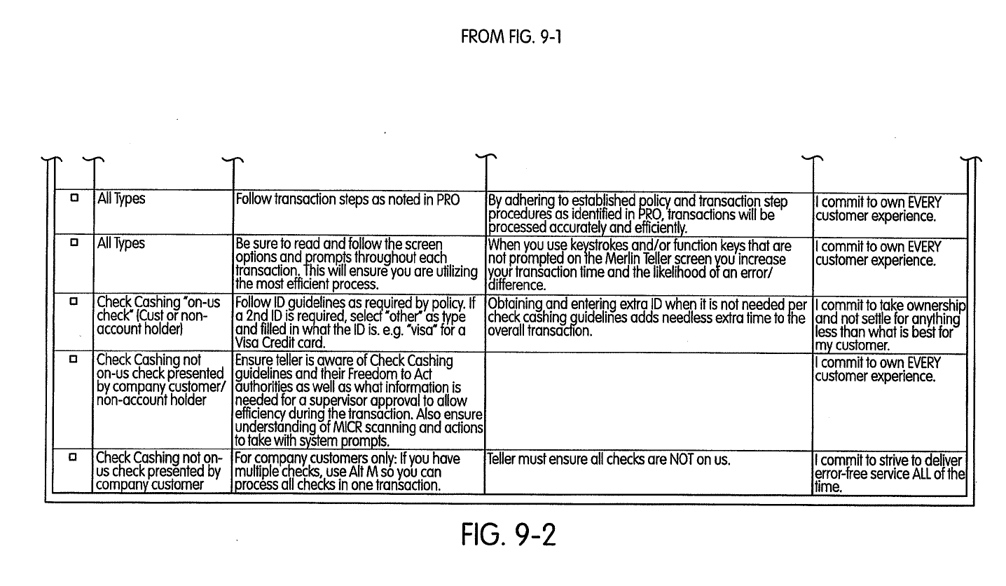

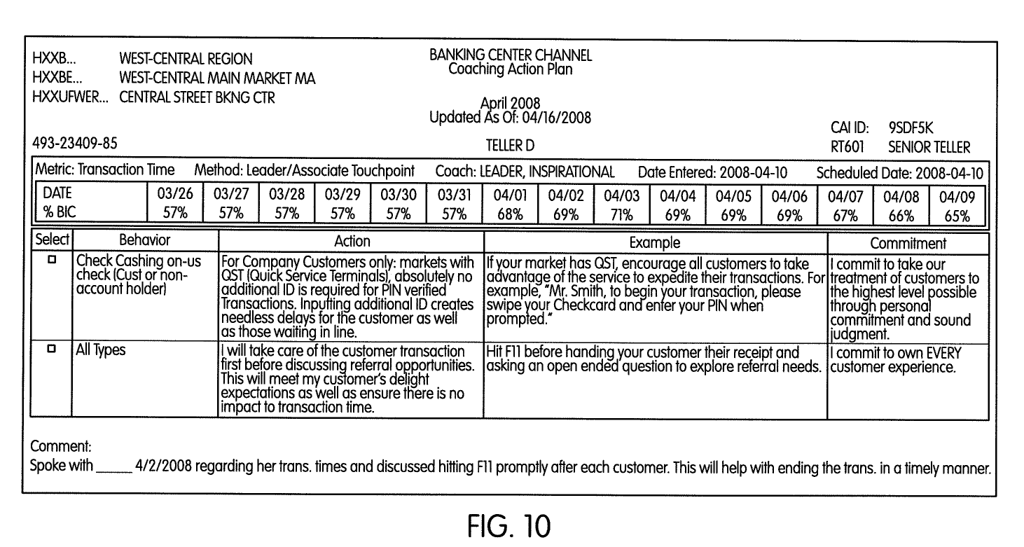

In an embodiment, the system provides a coaching wizard or tool to improve performance by tellers based on the performance metrics requiring improvement. For example, the coaching wizard may be utilized for Teller G to improve his sales performance from an L4 toward an L1. In this regard, FIG. 9 and FIG. 10 illustrate how tellers may be coached to improve their performance toward process capability. Referring first to FIG. 9, a table is provided for various type of coaching that could be provided to a teller. Each row in the table provides a coaching tool that could be used for a particular teller. Each row provides a behavior description, suggested actions that can be taken to improve performance, examples of the suggested actions, and the commitment that the teller should make to improve performance. By knowing the performance metrics requiring improvement, the coaching wizard may select the appropriate rows in the coaching table of FIG. 9. Once the appropriate behaviors are selected, an action plan may be developed for the teller. FIG. 10 provides a view of an action plan for a particular teller. The view provides a list of the selected behaviors (from FIG. 9) and provides a summary of how the teller has been coached and his/her BIC performance leading up to the date the action plan was developed.

While illustrative embodiments described herein embody various aspects are shown, it will be understood by those skilled in the art that the invention is not limited to these embodiments. Modifications may be made by those skilled in the art, particularly in light of the foregoing teachings. For example each of the elements of the aforementioned embodiments may be utilized alone or in combination or sub-combinations with the elements of the other embodiments. It will also be appreciated and understood that modification may be made without departing from the true spirit and scope of the present intention. The description is thus to be regarded as illustrative instead of restrictive on the present intention.

We claim:

1. A tangible computer-readable medium storing computer-executable instructions configured to cause a processor to perform a method comprising:
a. receiving performance information for a plurality of bank tellers, wherein the performance information relates to a plurality of performance metrics being measured for each bank teller for which performance information is received;
b. processing the received performance information to generate at least one report relating to performance for the plurality of bank tellers, wherein the report comprises, for at least one performance metric, a determined performance level from a plurality of possible performance levels for each of the plurality of bank tellers; and
c. displaying the determined performance levels for at least one of the plurality of bank tellers for the at least one performance metric.

2. The computer-readable medium of claim 1, wherein the determined performance level is determined from a predetermined percentage of top performing bank tellers for any given performance metric.

3. The computer-readable medium of claim 1, wherein the report further comprises a determined overall performance level for each of the plurality of bank tellers.

4. The computer-readable medium of claim 1, wherein the method further comprises:
d. providing a coaching tool to any of the bank tellers performing below a threshold performance level, wherein the coaching tool provides coaching to improve performance specific to the at least one performance metric.

5. The computer-readable medium of claim 1, wherein the report comprises performance levels for a plurality of performance metrics, and the method further comprises:
d. providing a coaching tool to any of the bank tellers performing below a threshold performance level for any of the performance metrics, wherein the coaching tool selects behaviors pertaining to the performance metric needing improvement and develops an action plan for the bank teller.

6. The computer-readable medium of claim 1, wherein the method further comprises:
d. generating a usage report for at least one bank teller that shows a number of days in a given period that the teller viewed the report relating to performance for the plurality of bank tellers.

7. The computer-readable medium of claim 1, wherein the method further comprises:
d. generating a detailed report for a particular bank teller.

8. The computer-readable medium of claim 1, wherein the method further comprises:
d. generating market level report reflecting overall performance by bank tellers at various bank branches within a given market.

9. The computer-readable medium of claim 1, wherein the method further comprises:
d. generating regional or divisional level report reflecting overall performance by bank tellers at various bank branches within a region or division.

10. The computer-readable medium of claim 1, wherein the receiving step comprises receiving performance information from a plurality of source systems.

11. The computer-readable medium of claim 1, wherein the receiving step comprises receiving performance information from at least one source system at a local branch bank.

12. The computer-readable medium of claim 1, wherein the receiving step comprises receiving performance information from at least one source system provided by a customer survey vendor.

13. The computer-readable medium of claim 1, wherein the processing step comprises selecting at least one bank teller to remove from the processing step.

14. The computer-readable medium of claim 13, wherein the selecting at least one bank teller step is performed to remove recently-hired bank tellers.

15. The computer-readable medium of claim 1, wherein the processing step comprises generating at least one report wherein the plurality of bank tellers are segmented according to at least one of employment status, geographic region, and bank branch.

16. The computer-readable medium of claim 15, wherein the selecting at least one bank teller step is performed to remove bank tellers that have not yet worked a threshold number of days.

17. A system, comprising:
a. a processor; and
b. a memory storing computer-executable instructions configured to cause the processor to perform a method comprising:
(i) receiving performance information from a plurality of source systems for a plurality of bank tellers, wherein the performance information relates to a plurality of performance metrics being measured for each bank teller for which performance information is received;
(ii) processing the received performance information to generate at least one report relating to performance for the plurality of bank tellers, wherein the report comprises, for at least one performance metric, a determined performance level from a plurality of possible performance levels for each of the plurality of bank tellers;
(iii) displaying the determined performance levels of each of the plurality of bank tellers for the at least one performance metric; and
(iv) providing a coaching tool to any of the bank tellers performing below a threshold performance level to improve performance with respect to the at least one performance metric.

18. The system of claim 17, wherein the determined performance level is determined from a predetermined percentage of top performing bank tellers for any given performance metric.

19. The system of claim 17, wherein the report further comprises a determined overall performance level for each of the plurality of bank tellers.

20. The system of claim 17, wherein the method further comprises:
(iv) generating a usage report for at least one bank teller that shows the number of days in a given period that the teller viewed the report relating to performance for the plurality of bank tellers.

21. The system of claim 17, wherein the processing step comprises selecting at least one bank teller to remove from the processing step.

22. The system of claim 17, wherein the processing step comprises generating at least one report wherein the plurality of bank tellers are segmented according to at least one of an employment status, geographic region, and bank branch.
